(19) United States
(12) Patent Application Publication
(10) Pub. No.: US 2014/0210263 A1
(43) Pub. Date: Jul. 31, 2014

(54) DATA CENTER AND POWER SUPPLY SYSTEM THEREOF

(71) Applicant: HON HAI PRECISION INDUSTRY CO., LTD., New Taipei (TW)

(72) Inventor: SHOU-KUO HSU, Tu-Cheng (TW)

(73) Assignee: HON HAI PRECISION INDUSTRY CO., LTD., New Taipei (TW)

(21) Appl. No.: 14/160,562

(22) Filed: Jan. 22, 2014

(30) Foreign Application Priority Data
Jan. 28, 2013 (TW) 102103228

(51) Int. Cl. H02J 1/00

(52) U.S. Cl. CPC H02J 1/00
USPC 307/23; 307/31

(57) ABSTRACT

A data center includes a plurality of electronic devices, a plurality of cooling devices, and a power supply system. Each electronic device includes a power supply unit (PSU). The power supply system includes an alternating current (AC) power supply, an energy router electrically connected to the AC power supply to receive power from the AC power supply, and a high voltage direct current transmission (HVDC) system. The HVDC system is electrically connected to the energy router, each PSU, and each cooling device. The HVDC system receives power form the energy router, converts the received power into a high voltage direct current, and outputs the high voltage direct current to each PSU and each cooling device. Each PSU converts the high voltage direct current into an operation voltage of the electronic device to power the electronic device.

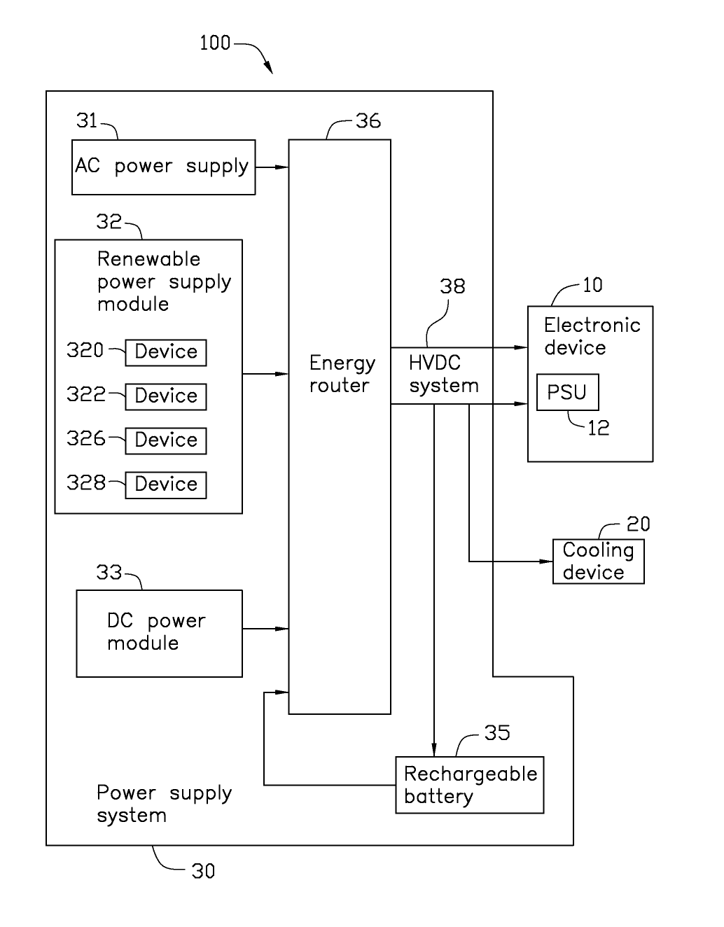

### BACKGROUND

1. Technical Field

The present disclosure relates to data centers, and particularly to a data center with a power supply system.

2. Description of Related Art

Data centers typically include a number of servers and a number of cooling devices. Powering these servers and cooling devices is expensive. Therefore, there is room for improvement in the art.

### BRIEF DESCRIPTION OF THE DRAWING

Many aspects of the present disclosure can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

The FIGURE is a block diagram of an embodiment of a data center.

### DETAILED DESCRIPTION

The disclosure, including the accompanying drawing, is illustrated by way of examples and not by way of limitation. It should be noted that references to “an” or “one” embodiment in this disclosure are not necessarily to the same embodiment, and such references can mean “at least one.”

The FIGURE shows an embodiment of a data center 100. The data center 100 comprises a plurality of electronic devices 10 (only one electronic device 10 is shown in the FIGURE), a plurality of cooling devices 20 (only one cooling device 20 is shown in the FIGURE), and a power supply system 30. Each electronic device 10 comprises a power supply unit (PSU) 12 to power the electronic device 10. The power supply system 30 supplies power to each PSU 10 and each cooling device 20. The cooling devices 20 cools the data center 100. In one embodiment, the electronic devices 10 may be servers, and the cooling devices 20 may be fans.

The power supply system 30 comprises an alternating current (AC) power supply 31, a renewable power supply module 32, a direct current (DC) power module 33, a rechargeable battery 35, an energy router 36, and a high voltage direct current transmission (HVDC) system 38. The energy router 36 is electrically connected to the AC power supply 31, the renewable power supply module 32, the DC power module 33, the rechargeable battery 35, and the HVDC system 38. The HVDC system 38 is further electrically connected to each PSU 12, each cooling device 20, and the rechargeable battery 35.

In one embodiment, the renewable power supply module 32 comprises a device 320 transforming solar energy into electric energy, a device 322 transforming wind energy into electric energy, a device 326 transforming tidal energy into electric energy, and a device 328 transforming geothermal energy into electric energy. One or more such devices can be selected to operate, according to environment around the data center 100. In other embodiments, the number of the energy router 36 can be adjusted according to actual need.

In use, the energy router 36 receives power from one or more of the AC power supply 31, the renewable power supply module 32, the DC power module 33, and outputs the received power to the HVDC system 38. The HVDC system 38 converts the received power into a high voltage direct current and outputs the high voltage direct current to each PSU 12, each cooling device 20, and the rechargeable battery 35. The PSU 12 converts the high voltage direct current into an operation voltage, such as 12 volts, of the electronic device 10 to power the electronic device 10. The rechargeable battery 35 is charged by the high voltage direct current of the HVDC system 38 and supplies power to the energy router 36 when all of the AC power supply 31, the renewable power supply module 32, the DC power module 33 do not operate.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A power supply system to power a data center, the data center comprising a plurality of electronic devices and a plurality of cooling devices, each electronic device comprising a power supply unit (PSU), the power supply system comprising:
an alternating current (AC) power supply;
at least one energy router electrically connected to the AC power supply to receive power from the AC power supply; and
a high voltage direct current transmission (HVDC) system electrically connected to the at least one energy router, each PSU, and each cooling device;
wherein HVDC system receives power from the at least one energy router, converts the received power into a high voltage direct current, and outputs the high voltage direct current to each PSU and each cooling device, each PSU converts the high voltage direct current into an operation voltage of the electronic device to power the electronic device.

2. The power supply system of claim 1, further comprising a renewable power supply module electrically connected to the at least one energy router to supply power to the at least one energy router, wherein the renewable power supply module comprises a first device transforming solar energy into electric energy, a second device transforming wind energy into electric energy, a third device transforming tidal energy into electric energy, and a fourth device transforming geothermal energy into electric energy.

3. The power supply system of claim 1, further comprising a direct current (DC) power module electrically connected to the at least one energy router to supply power to the at least one energy router.

4. The power supply system of claim 1, further comprising a rechargeable battery electrically connected to the at least one energy router and the HVDC system, wherein the rechargeable battery is charged by the HVDC system and supplies power to the at least one energy router.

5. A data center comprising:
a plurality of electronic devices, each electronic device comprising a power supply unit (PSU);
a plurality of cooling devices to cool the data center; and
a power supply system comprising:
an alternating current (AC) power supply;
at least one energy router electrically connected to the AC power supply to receive power from the AC power supply; and.
a high voltage direct current transmission (HVDC) system electrically connected to the at least one energy router, each PSU, and each cooling device;
wherein HVDC system receives power from the at least one energy router, converts the received power into a high voltage direct current, and outputs the high voltage direct current to each PSU and each cooling device, each PSU converts the high voltage direct current into an operation voltage of the electronic device to power the electronic device.

6. The data center of claim 5, wherein the power supply system further comprises a renewable power supply module electrically connected to the at least one energy router to supply power to the at least one energy router, the renewable power supply module comprises a first device transforming solar energy into electric energy, a second device transforming wind energy into electric energy, a third device transforming tidal energy into electric energy, and a fourth device transforming geothermal energy into electric energy.

7. The data center of claim 5, wherein the power supply system further comprises a direct current (DC) power module electrically connected to the at least one energy router to supply power to the at least one energy router.

8. The data center of claim 5, wherein the power supply system further comprises a rechargeable battery electrically connected to the at least one energy router and the HVDC system, the rechargeable battery is charged by the HVDC system and supplies power to the at least one energy router.
